(19) United States
(12) Patent Application Publication
(10) Pub. No.: US 2024/0308039 A1
(43) Pub. Date: Sep. 19, 2024

(54) TORQUE WRENCH THAT CAN DETECT ACCURACY OF TRIPPING TORQUE AND A CORRECTION METHOD THEREOF

(71) Applicant: Shih-Hao LAI, Taichung City (TW)

(72) Inventor: Shih-Hao LAI, Taichung City (TW)

(21) Appl. No.: 18/600,036

(22) Filed: Mar. 8, 2024

(30) Foreign Application Priority Data
Mar. 13, 2023 (TW) 112109222
Dec. 1, 2023 (TW) 112146923

(51) Int. Cl. B25B 23/142

(52) U.S. Cl. CPC B25B 23/1425

(57) ABSTRACT

A torque wrench capable of detecting the accuracy of tripping torque includes a shaft tube, a drive rod, a tripping mechanism arranged in the shaft tube and connected to the drive rod, an adjustment mechanism arranged in the shaft tube, and a measuring device usable for measuring a torque value that applies to the drive rod connected to the shaft tube. The measuring device is usable for setting a target torque value. The target torque value is based on determining an allowable error range. The allowable error range is in a range of 0.85 times more and 1.15 times less than the target torque value. In a situation where a force is applied to the torque wrench until the tripping mechanism trips, the measuring device obtains a tripping torque value and is usable for detecting whether the tripping torque value is within the allowable error range.

### BACKGROUND OF THE INVENTION

The present invention relates to a torque wrench and, more particularly, to a torque wrench that can detect the accuracy of tripping torque.

TW Pat. No. 201444651 discloses a torque wrench that can rectify torque. The wrench includes a mechanical structure and an electronic structure. The mechanical structure includes a pipe body, a flexible rod installed on the pipe body, a holding member, an elastic element, a tripping mechanism, an adjustment mechanism, and a mechanical scale mark structure to display a predetermined torque set by the wrench. The electronic structure includes at least one torque sensor and a display unit. The sensor, located on one side of the deflection rod, is used to detect the deformation of the deflection rod. To rectify the torque value of the mechanical structure, a force is exerted on the wrench to prompt the sensor to register a new torque value. Subsequently, the torque value of the mechanical structure is adjusted to align with the newly detected torque value, rectifying any discrepancies between the torque value and the new torque value.

It is noted that in order to set a tripping torque for the mechanical structure, the user must first actively compute an acceptable error range using this setting before exerting force with the torque wrench. Additionally, when the torque wrench trips, the sensor senses a torque value and determines if it matches the predetermined trip torque. It is inconvenient, therefore, that the user has to manually determine the acceptable error range. When using the torque wrench, the torque sensor shows the torque value at the moment of tripping, but the user may overlook the correction without even realizing it if they fail to calculate whether the tripping torque exceeds the error range.

The present invention is, therefore, intended to obviate or at least alleviate the problems encountered in the prior art.

### SUMMARY OF THE INVENTION

A torque wrench capable of detecting the accuracy of tripping torque includes a shaft tube, a drive rod with one end inserted into the shaft tube and another end disposed outside the shaft tube, a tripping mechanism arranged in the shaft tube and connected to the drive rod, an adjustment mechanism arranged in the shaft tube and on a side of the tripping mechanism opposite to that of the drive rod, and a measuring device connected to the shaft tube. The adjustment mechanism is provided with an adjustment button. The measuring device is usable for measuring a torque value that applies to the drive rod and setting a target torque value. The adjustment button is adjustable to change a tripping torque value that causes the tripping mechanism to trip and the target torque value simultaneously. The target torque value is based on determining an allowable error range. The allowable error range is in a range of 0.85 times more and 1.15 times less than the target torque value. In a situation where a force is applied to the torque wrench until the tripping mechanism trips, the measuring device measures the torque value to the drive rod and obtains the tripping torque value. The measuring device is usable for detecting whether the tripping torque value is within the allowable error range; if not, it sends out a negative signal; if so, it either sends out a positive signal or does not send a signal at all.

Further, a correction method thereof comprises steps: setting a target torque value with the measuring device and using the adjustment button to simultaneously change a tripping torque that causes the tripping mechanism to trip and the target torque value for a step for setting a target torque value; applying a force to the torque wrench until the tripping mechanism trips and using the measuring device to measure the torque value to the drive rod as the tripping mechanism trips and to obtain the tripping torque value for a step for measuring the torque value; and using the target torque value for determining an allowable error range, which is in a range of 0.85 times more and 1.15 times less than the target torque value, and using the measuring device to detect whether the tripping torque value is within the allowable error range; if not, it sends out a negative signal; if so, it either sends out a positive signal or does not send a signal at all for a step for comparing the torque value with the target torque value.

There has thus been outlined, rather broadly, the more important features of the invention in order that the detailed description thereof that follows may be better understood, and in order that the present contribution to the art may be better appreciated. There are additional features of the invention that will be described hereinafter and which will form the subject matter of the claims appended hereto.

In this respect, before explaining at least one embodiment of the invention in detail, it is to be understood that the invention is not limited in its application to the details of construction and to the arrangements of the components set forth in the following description or illustrated in the drawings. The invention is coverable of other embodiments and of being practiced and carried out in various ways. Also, it is to be understood that the phraseology and terminology employed herein are for the purpose of description and should not be regarded as limiting.

As such, those skilled in the art will appreciate that the conception, upon which this disclosure is based, may readily be utilized as a basis for the designing other structures, methods and systems for carrying out the several purposes of the present invention. It is important, therefore, that the claims be regarded as including such equivalent constructions insofar as they do not depart from the spirit and scope of the present invention.

Further, the purpose of the abstract is to enable the public generally, and especially scientists, engineers and practitioners in the art who are not familiar with patent or legal terms or phraseology, to determine quickly from a cursory inspection the nature and essence of the technical disclosure. The abstract is neither intended to define the invention, which is measured by the claims, nor is it intended to be limiting as to the scope of the invention in any way.

Other objectives, advantages, and new features of the present invention will become apparent from the following detailed description of the invention when considered in conjunction with the accompanied drawings.

### BRIEF DESCRIPTION OF DRAWINGS

FIG. 1 is a perspective view of a torque wrench capable of detecting the accuracy of tripping torque according to the present invention.

FIG. 2 is a plan view of the torque wrench of FIG. 1.

FIG. 3 is a plan view of the torque wrench of FIG. 1.

FIG. 4 is an exploded perspective view of the torque wrench of FIG. 1.

FIG. 5 is a cross-sectional view of the torque wrench of FIG. 1.

FIG. 6 is the flowchart of a correction method for a torque wrench capable of detecting the accuracy of tripping torque according to the present invention.

### DETAILED DESCRIPTION OF THE INVENTION

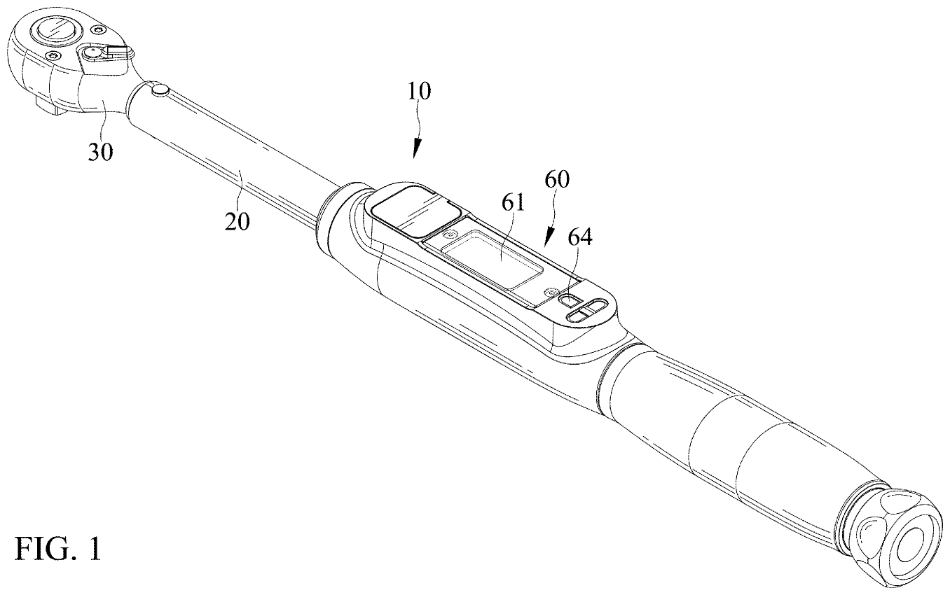

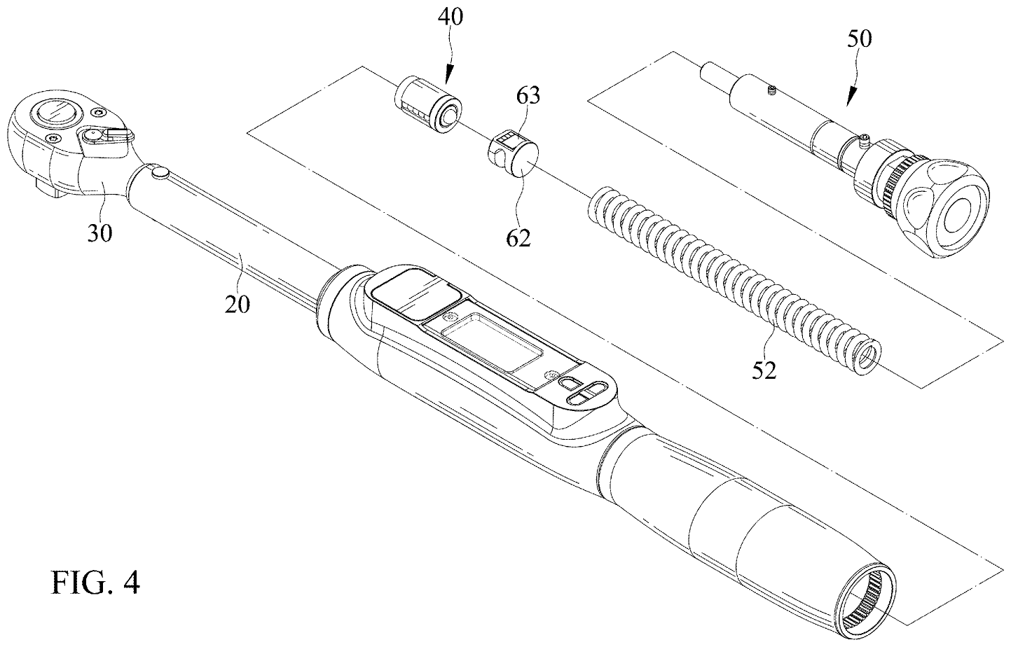

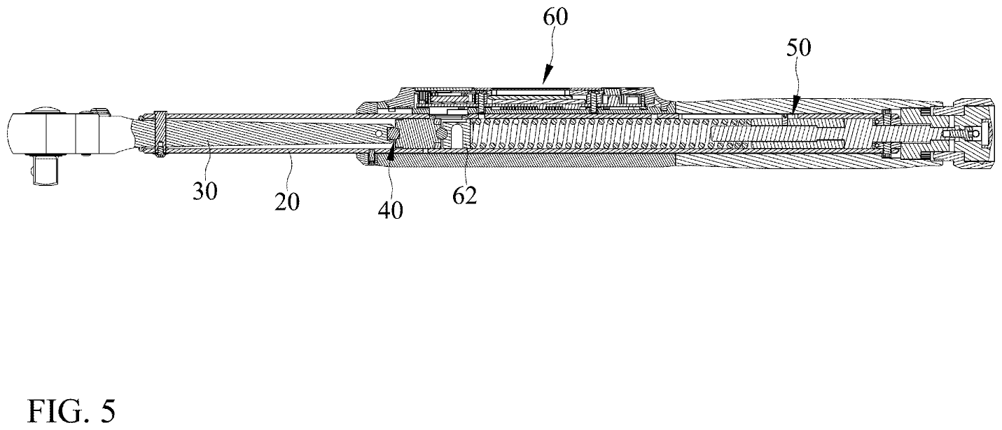

FIGS. 1-5 show a torque wrench 10 capable of detecting the accuracy of tripping torque according to the present invention includes a shaft tube 20, a drive rod 30, a tripping mechanism 40, an adjustment mechanism 50, and a measuring device 60.

The drive rod 30 includes one end inserted into the shaft tube 20 and another end disposed outside the shaft tube 20.

The tripping mechanism 40 is arranged in the shaft tube 20 and connected to the drive rod 30.

The adjustment mechanism 50 is arranged in the shaft tube 20 and on a side of the tripping mechanism 40 opposite to that of the drive rod 30. The adjustment mechanism 50 is provided with an adjustment button 51 and a spring 52.

The measuring device 60 is connected to the shaft tube 20. The measuring device 60 is provided with a strain gauge seat 62 and a strain gauge patch 63. The strain gauge seat 62 is disposed between the tripping mechanism 40 and the adjustment mechanism 50. The strain gauge patch 63 is attached to the strain gauge seat 62. The measuring device 60 is also provided with a setting button 64. Moreover, the measuring device 60 is provided with a display 61. The setting button 64 is adjacent to the display 61.

The adjustment button 51 is adjustable to change a tripping torque value that causes the tripping mechanism 40 to trip and the target torque value simultaneously. The target torque value is based on determining an allowable error range. The allowable error range is in a range of 0.85 times more and 1.15 times less than the target torque value. More preferably, the allowable error range is in a range of 0.96 times more and 1.04 times less than the target torque value.

The drive rod 30 is usable to engage with a workpiece. The measuring device 60 is usable for measuring a torque value to the drive rod 30 and setting a target torque value. The display 61 is usable to display the target torque value. The thrust of the spring 52 is able to transmit through the strain gauge seat 62 to the tripping mechanism 40. The strain gauge patch 63 is usable to measure a strain put on the strain gauge seat 62 by the thrust of the spring 52 and convert it into the target torque value through the measuring device 60. The setting button 64 is usable to set the target torque value.

When a force is applied to the torque wrench 10 until the tripping mechanism 40 trips, the measuring device 60 measures the torque value to the drive rod 30 and obtains the tripping torque value. The measuring device 60 is usable to detect whether the tripping torque value is within the allowable error range; if not, it sends out a negative signal; if so, it either sends out a positive signal or does not send a signal at all. The display 61 displays the tripping torque value that is not within the allowable error range when the negative signal is sent out, and displays the target torque value when the positive signal is sent out.

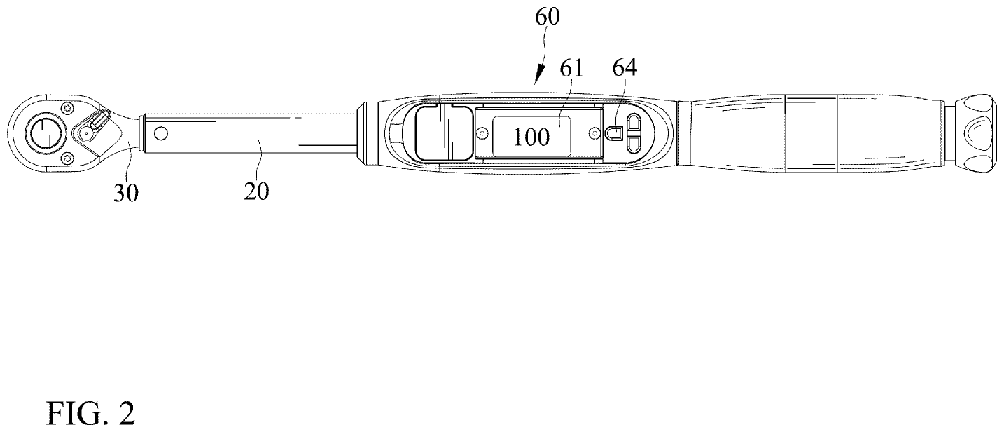

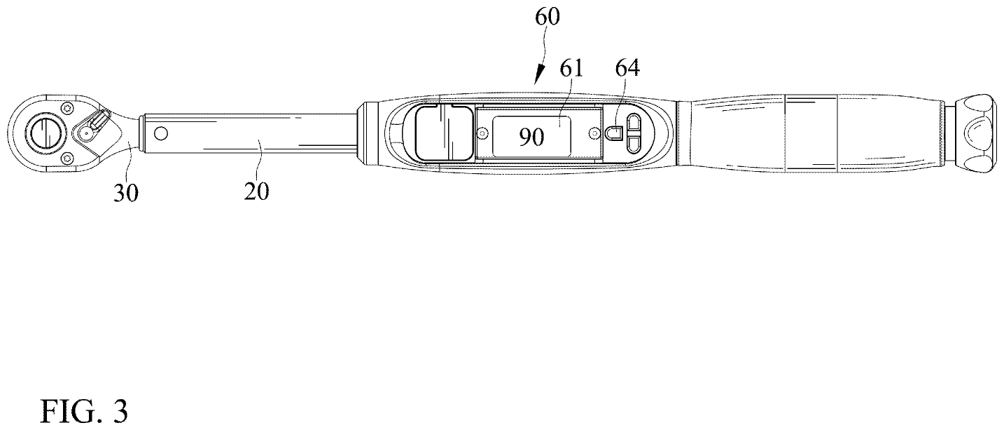

The example of the target torque value in this embodiment is 100 (as shown in FIG. 2), and the example of the tripping torque value in this embodiment is 90 (as shown in FIG. 3). When the target torque value is 100, the allowable error range is a value above 96 and below 104. Thus, the tripping torque value is 90 and is not within the allowable error range, and the user needs to adjust the adjustment mechanism 50 and increase the tripping torque value of the tripping mechanism 40. After completing the adjustment, the user performs the step of measuring the torque value again to confirm whether the corrected tripping torque value is within the allowable error range. The user repeats and carries out the above steps until the tripping torque value is within the allowable error range to complete the correction. Throughout the above method, the display 61 displays the tripping torque value that is not within the allowable error range when the negative signal is sent out, and displays the target torque value when the positive signal is sent out.

When using the torque wrench 10, the user sets the target torque value first, which is done by pressing the setting button 64 and adjusting the adjustment button 51 before engaging the driving rod 30 with the workpiece to be turned. Then, by turning the torque wrench 10 until the tripping mechanism 40 trips, the user can directly get information on whether the tripping torque value is accurate, i.e., within the allowable error range. If the tripping torque value is not accurate, the user adjusts the adjustment mechanism 50 according to the above correction method.

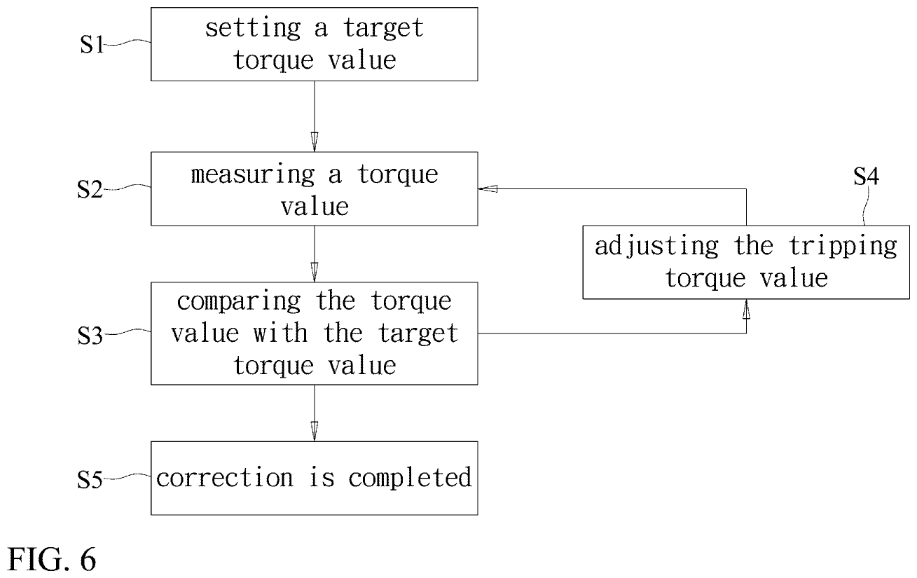

FIG. 6 shows a method for correcting the torque wrench 10 capable of detecting the accuracy of tripping torque according to the present invention. The method comprises steps: setting a target torque value with the measuring device 60 and using the adjustment button 51 to simultaneously change a tripping torque that causes the tripping mechanism 40 to trip and the target torque value for a step for setting a target torque value S1; applying a force to the torque wrench 10 until the tripping mechanism 40 trips and using the measuring device 60 to measure the torque value to the drive rod 30 as the tripping mechanism 40 trips and to obtain the tripping torque value for a step for measuring the torque value S2; using the target torque value for determining an allowable error range, which is in a range of 0.85 times more and 1.15 times less than the target torque value, and using the measuring device 60 to detect whether the tripping torque value is within the allowable error range; if not, it sends out a negative signal; if so, it either sends out a positive signal or does not send a signal at all for a step for comparing the torque value with the target torque value S3, a step for adjusting the tripping torque value S4, and a step in which the correction is completed S5. The step for adjusting the tripping torque value is carried out after the step for comparing the torque value with the target torque value S3 if the measuring device 60 detects the tripping torque value is not within the allowable error range and sends out the negative signal. The step in which the correction is completed S5 is carried out after the step for comparing the torque value with the target torque value S3 if the measuring device 60 detects the tripping torque value is within the allowable error range and sends out the positive signal or does not send the signal at all. Using the adjusting mechanism 50 to change the tripping torque value of the tripping mechanism 40 and carrying out the step of measuring the torque value again in order that the tripping torque value is within the allowable error range for the step for adjusting the tripping torque value. The step in which the correction is completed S5 shows an end of the correction method.

In view of the foregoing, the user can adjust and correct the tripping torque value easily through the above correction method. The user does not need to calculate the allowable error range and determine whether the tripping torque value is within the allowable error range. Further, it is worth mentioning that as long as the target torque value is set, the user can depend entirely on the signal from the measuring device 60 to determine whether the tripping torque value is accurate and make adjustments when the measuring device 60 sends out a negative signal. The user can adjust just using the adjustment mechanism 50. The user's negligence, which can cause a large torque error, is unlikely to happen.

Although specific embodiments have been illustrated and described, numerous modifications and variations are still possible without departing from the scope of the invention. The scope of the invention is limited by the accompanying claims.

1. A torque wrench capable of detecting the accuracy of tripping torque, comprising:
a shaft tube;
a drive rod with one end inserted into the shaft tube and another end disposed outside the shaft tube;
a tripping mechanism arranged in the shaft tube and connected to the drive rod;
an adjustment mechanism arranged in the shaft tube and on a side of the tripping mechanism opposite to that of the drive rod, wherein the adjustment mechanism is provided with an adjustment button;
a measuring device connected to the shaft tube, wherein the measuring device is usable for measuring a torque value to the drive rod and setting a target torque value; and
wherein the adjustment button is adjustable to change a tripping torque value that causes the tripping mechanism to trip and the target torque value simultaneously, wherein the target torque value is based on determining an allowable error range, wherein the allowable error range is in a range of 0.85 times more and 1.15 times less than the target torque value, wherein when a force is applied to the torque wrench until the tripping mechanism trips, the measuring device measures the torque value to the drive rod and obtains the tripping torque value, and wherein the measuring device is usable to detect whether the tripping torque value is within the allowable error range; if not, it sends out a negative signal; if so, it either sends out a positive signal or does not send a signal at all.

2. The torque wrench as claimed in claim 1, wherein the measuring device is provided with a display that displays the tripping torque value that is not within the allowable error range when the negative signal is sent out, and displays the target torque value when the positive signal is sent out.

3. The torque wrench as claimed in claim 1, wherein the measuring device is provided with a strain gauge seat and a strain gauge patch, wherein the strain gauge seat is disposed between the tripping mechanism and the adjustment mechanism, and wherein the strain gauge patch is attached to the strain gauge seat.

4. The torque wrench as claimed in claim 1, wherein the allowable error range is in a range of 0.96 times more and 1.04 times less than the target torque value.

5. The torque wrench as claimed in claim 3, wherein the measuring device is provided with a setting button that is usable to set the target torque value, wherein the target torque value is displayed on the display, wherein the setting button is adjacent to the display, wherein the adjustment mechanism is provided with a spring and the thrust of the spring is able to transmit through the strain gauge seat to the tripping mechanism, and wherein the strain gauge patch is usable to measure a strain put on the strain gauge seat by the thrust of the spring and convert it into the target torque value through the measuring device.

6. A method for correcting a torque wrench capable of detecting the accuracy of tripping torque, wherein the torque wrench includes a shaft tube, a drive rod, a tripping mechanism, an adjusting mechanism, and a measuring device, wherein the drive rod has one end inserted into the shaft tube and another end disposed outside the shaft tube, wherein the tripping mechanism is arranged in the shaft tube and connected to the drive rod, wherein the adjustment mechanism is arranged in the shaft tube and on a side of the tripping mechanism opposite to that of the drive rod, wherein the adjustment mechanism is provided with an adjustment button, wherein the measuring device usable for measuring a torque value to the drive rod is connected to the shaft tube, and wherein the method comprises steps:
setting a target torque value with the measuring device and using the adjustment button to simultaneously change a tripping torque that causes the tripping mechanism to trip and the target torque value for a step for setting a target torque value;
applying a force to the torque wrench until the tripping mechanism trips and using the measuring device to measure the torque value to the drive rod as the tripping mechanism trips and to obtain the tripping torque value for a step for measuring the torque value; and
using the target torque value for determining an allowable error range, which is in a range of 0.85 times more and 1.15 times less than the target torque value, and using the measuring device to detect whether the tripping torque value is within the allowable error range; if not, it sends out a negative signal; if so, it either sends out a positive signal or does not send a signal at all for a step for comparing the torque value with the target torque value.

7. The method as claimed in claim 6, wherein the method further comprising a step for adjusting the tripping torque value and a step in which the correction is completed, wherein the step for adjusting the tripping torque value is carried out after the step for comparing the torque value with the target torque value if the measuring device detects the tripping torque value is not within the allowable error range and sends out the negative signal, wherein the step in which the correction is completed is carried out after the step for comparing the torque value with the target torque value if the measuring device detects the tripping torque value is within the allowable error range and sends out the positive signal or does not send the signal at all, wherein using the adjusting mechanism to change the tripping torque value of the tripping mechanism and carrying out the step of measuring the torque value again in order that the tripping torque value is within the allowable error range for the step for adjusting the tripping torque value; and wherein the step in which the correction is completed shows an end of the correction method.

8. The method as claimed in claim 6, wherein the measuring device is provided with a display that displays the tripping torque value that is not within the allowable error range when the negative signal is sent out.

9. The method as claimed in claim 7, wherein the measuring device is provided with a display that displays the tripping torque value that is not within the allowable error range when the negative signal is sent out.

10. The method as claimed in claim 8, wherein the display displays the target torque value when the positive signal is sent out.

11. The method as claimed in claim 9, wherein the display displays the target torque value when the positive signal is sent out.

12. The method as claimed in claim 8, wherein the measuring device is provided with a strain gauge seat and a strain gauge patch, wherein the strain gauge seat is disposed between the tripping mechanism and the adjustment mechanism, and wherein the strain gauge patch is attached to the strain gauge seat.

13. The method as claimed in claim 6, wherein the allowable error range is in a range of 0.96 times more and 1.04 times less than the target torque value.

14. The method as claimed in claim 7, wherein the allowable error range is in a range of 0.96 times more and 1.04 times less than the target torque value.

15. The method as claimed in claim 12, wherein the measuring device is provided with a setting button that is usable to set the target torque value, wherein the target torque value is displayed on the display, wherein the setting button is adjacent to the display, wherein the adjustment mechanism is provided with a spring and the thrust of the spring is able to transmit through the strain gauge seat to the tripping mechanism, and wherein the strain gauge patch is usable to measure a strain put on the strain gauge seat by the thrust of the spring and convert it into the target torque value through the measuring device.
